(19) United States
(12) Patent Application Publication
(10) Pub. No.: US 2007/0039684 A1
(43) Pub. Date: Feb. 22, 2007

(54) Method and apparatus for separating labels from a liner

(76) Inventor: Greydon Wesley Nedblake, Kansas City, MO (US)

Correspondence Address: HOVEY WILLIAMS LLP, 2405 GRAND BLVD., SUITE 400, KANSAS CITY, MO, 64108, US

(21) Appl. No.: 11/206,423

(22) Filed: Aug. 18, 2005

(51) Int. Cl. B65C 1/00; B32B 37/00; B65C 3/00; B65C 9/18; B65C 9/26; B65C 9/34

(52) U.S. Cl. 156/249; 156/247; 156/285; 156/541; 156/542; 156/DIG. 1; 156/DIG. 5; 156/DIG. 33; 156/DIG. 37; 156/DIG. 41

(57) ABSTRACT

Methods and apparatus for applying labels to products by effecting a complete or partial pre-release of the label from the carrier web are provided. Such initial de-lamination alters the label release value thereby enabling more consistent label application without unduly increasing web tension. Final label de-lamination may be aided using vacuum assist apparatus.

### BACKGROUND OF THE INVENTION

1. Field of the Invention

The present invention is generally directed toward methods and apparatus for separating labels, or at least a portion thereof, from a carrier web or liner and applying the labels to products. More specifically, the methods and apparatus allow for easy separation of labels having a high initial release value from their carrier web prior to being applied to products.

2. Description of the Prior Art

Reel-fed, pressure-sensitive labels generally comprise a laminate of face material, adhesive, release coating, and carrier web wound as a continuous reel. This construction is the means by which individual pressure sensitive labels are printed and converted from master reels into smaller reels suitable for use on common label dispensing systems. The most conventional method by which individual labels are released from the carrier web is by drawing the liner under controlled tension around the tip of a beak or peeler plate. This action induces a separated force, due to the stiffness of the face material, greater than the label adhesive attachment to the silicon substrate encouraging the label to break away from the liner in preparation for application onto its designated product.

Pressure sensitive labels and liner can be constructed from a variety of materials including paper, synthetic materials, and combinations thereof having varying physical characteristics such as thickness (calliper), elasticity, and stiffness. In addition, different adhesive types and formulations, together with different coat-weights, are employed as best suited to the type of container and environmental conditions. The coat-weight and type of release coating process used to coat the liner can also be varied which will affect the attachment value of the label adhesive. The attachment value is often referred to as the “release value” which is determined using known Finat testing procedures.

The relationship between these variables has a direct influence on the release value which in turn will affect the dispense characteristics of the label from the carrier web. For any given combination of label, adhesive, and release substrate there should always be a usable band of release values that enable good dispense of the label without the use of excessive web tension or the possibility of the label delaminating from the web prior to intended release. For most combinations of standard label construction, these values are well known giving reliable and consistent label dispensing at the point of application. However, if recommended storage conditions or defective conversion/finishing of the reels take place, then it is possible that the label release may become inconsistent resulting in labels failing to dispense properly or being misapplied to the product.

Recent developments in the coating and conversion of down gauged or thinner films have necessitated a proportionate reduction in release values to a point where the usable band of consistent release has become extremely narrow with little or no margin. Therefore, any variations in quality, storage conditions, or web tension control have an immediate impact on label dispense consistency. Efforts have been made to reduce the release value on thin films to give consistent dispense without excessive web tension, but cannot be demonstrated to work effectively on thin films below 18 microns. This is especially true for thin films with cavitation or color pigmentation as a part of their construction, such as white polypropylene, or highly flexible thin films such as polyethylene. The situation is worsened when the carrier web has an ultra-smooth surface such as with a PET liner. While it is possible to lessen these effects by increasing the web tension and/or reducing the tip radius of the peeler plate, the likelihood of web stretch or web snap significantly increase and reduce the reliability of label application.

Therefore, a need exists for a method and apparatus for consistently dispensing labels which would be difficult to consistently dispense by conventional means.

### SUMMARY OF THE INVENTION

The present invention overcomes the above difficulties using a system whereby a label is partially or fully pre-released from the carrier web and then re-laminated prior to drawing the web around a peel plate or peel roller thereby effecting final release of the label. By breaking the adhesive attachment, the release value of the label is reduced. Lowering the release value provides improved dispense characteristics without imposing undesirable web tension on labels which would otherwise fail to release at all or dispense inconsistently. The system also provides for the reduction or elimination of unintended label pre-release due to excessively low silicon release values relative to the laminate construction.

In one aspect, the invention pertains to a method of applying labels to products comprising the steps of: (a) guiding a web comprising a plurality of pre-printed labels along a path; (b) applying a first vacuum to at least one of the labels proximate the leading edge thereof as the web travels along the path; (c) separating at least the leading edge of the label from the web; (d) reapplying the leading edge of the at least one label on the web; and (e) transporting the at least one label to a label application station where the at least one label is applied to a product.

In another aspect, the invention is directed toward a method of applying labels to products comprising the steps of: (a) guiding a web comprising a plurality of pre-printed labels along a path; (b) stripping at least one of the labels from the web as the web travels along the path; (c) repositioning the at least one label on the web; and (d) directing the web to a label application station where the at least one label is applied to a product.

In yet another aspect, the invention is directed toward a method of applying labels to products comprising the steps of: (a) guiding a web comprising a plurality of pre-printed labels along a path; (b) applying a vacuum to at least one of the labels proximate at least the leading edge thereof as the web travels along the path, the vacuum applied by a first vacuum belt; (c) stripping the web from the at least one label, the at least one label being adhered to the first vacuum belt; (d) transferring the at least one label from the first vacuum belt to a pitching belt, the pitching belt altering the pitch between the at least one label and at least one other label; and (e) transferring the at least one label from the pitching belt to an application belt which transports the at least one label to a label application station.

In still another aspect, the invention is directed toward an apparatus for applying labels to products comprising: a continuous web comprising a plurality of pre-printed labels; a first vacuum device for selectively applying a vacuum to at least one of the labels proximate the leading edge thereof and separating at least a portion of the at least one label from the web, the vacuum device further configured to reapply the portion of the at least one label on the web; and a label application station where the at least one label is stripped from the web and applied to a product.

### BRIEF DESCRIPTION OF THE DRAWINGS

FIG. 1 is a schematic view of a label dispensing system wherein individual labels undergo complete pre-release and vacuum assisted stripping from the carrier web.

FIG. 2 is an alternate embodiment of the label dispensing system illustrated in FIG. 1.

FIG. 3 is a schematic view of a label dispensing system wherein individual labels undergo complete pre-release and re-application to the carrier web prior to application to products.

FIG. 4 is a diagram of an alternate release mechanism whereby the leading edge of a label is contacted with suction supplied by a vacuum drum.

FIG. 5 depicts the suction separating the leading portion of the label from the carrier web as the vacuum drum rotates and the web continues along a path.

FIG. 6 depicts the use of positive pressure air to reapply the leading portion of the label to the web.

FIG. 7 is a schematic view of a label dispensing system including apparatus for pitching the labels prior to being applied to products.

FIG. 8 is a top view of the label dispensing system of FIG. 7.

### DETAILED DESCRIPTION OF THE PREFERRED EMBODIMENT

The following description sets forth preferred methods of applying labels to products and apparatus for carrying out the same. It is to be understood, however, that this description is provided by way of illustration and nothing therein should be taken as a limitation upon the overall scope of the invention.

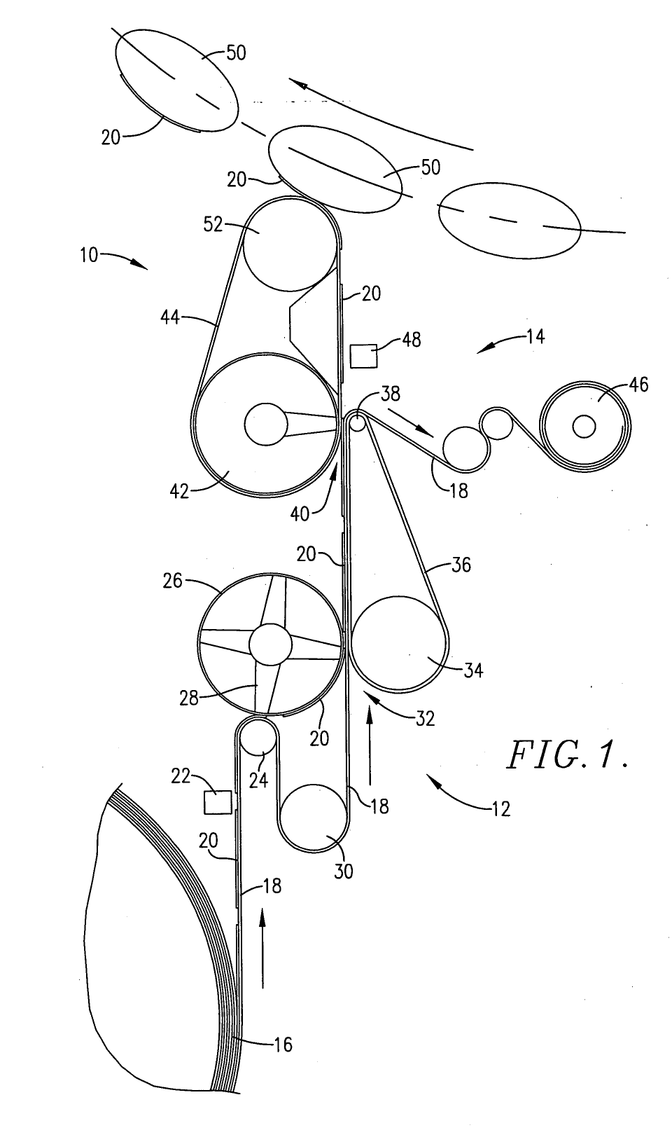

Turning now to FIG. 1, a label application system 10 is shown that includes a label pre-release station 12 and a label application station 14. A reel 16 comprising a liner web 18 having a plurality of pressure sensitive labels 20 disposed thereon is provided. Preferably, labels 20 are preprinted so that reel 16 is simply changed out from time to time. However, it is within the scope of the present invention for reel 16 to be replaced with an on-demand label making system such as that disclosed in U.S. Pat. No. 6,863,756, incorporated by reference herein.

Preferably, the labels used in conjunction with the present invention have a thickness of between about 0.1-3 mils, more preferably between about 0.1-2 mils, and most preferably between about 0.2-1 mils. Preferred labels also comprise release values of at least 15 grams, more preferably between about 15.5-30 grams, and most preferably between about 16-25 grams, as determined by Finat testing procedures.

Web 18 is guided along a path indicated by the arrows. Initially, web 18 passes by sensor 22, preferably an optical scanner, which senses the position of individual labels 20 on web 18. Web 18 is guided between nip roller 24 and a first vacuum drum 26. Vacuum drum 26 includes a plurality of vacuum apertures 28 through which the vacuum is primarily directed. Vacuum drum 26 is preferably servo controlled using the output from sensor 22. Sensor 22 detects the leading edge of a particular label 20 so that by the time label 20 reaches vacuum drum 26, aperture 28 is in position to apply suction to the label proximate the leading edge thereof. Preferably, the vacuum is engaged on the leading edge of the label.

The strength of the vacuum is such that as vacuum drum 26 rotates in a counterclockwise direction, label 20 is completely stripped from web 18. Web 18 continues around roller 30 and is guided toward nip 32 which is formed by vacuum drum 26 and nip roller 34. At nip 32, label 20 is re-laminated to web 18 and the suction force by vacuum drum 26 proximate the leading edge of label 20 is subsequently released. As label 20 passes through nip 32, the remaining portion of label 20 is re-attached to web 18.

Web 18 is then directed toward label application station 14. Belt 36 which is entrained around nip roller 34 and peel roller 38 assists in guiding web 18 toward nip 40 formed by vacuum drum 42 and peel roller 38. At nip 40, a vacuum is applied to label 20 proximate the leading edge thereof so that the label adheres to vacuum belt 44 as web 18 is directed around peel roller 38. Web 18 is then taken up on waste roll 46. Label 20 continues along vacuum belt 44 and passes sensor 48, preferably an optical sensor, which is used to coordinate the pitching of labels 20 to match the pitch of incoming products 50. The rotation of vacuum belt 44, vacuum drum 42, and application roller 52 is preferably servo controlled so that the pitch between labels 20 may be adjusted as needed. Finally, label 20 is applied to product 50 with the aid of application roller 52.

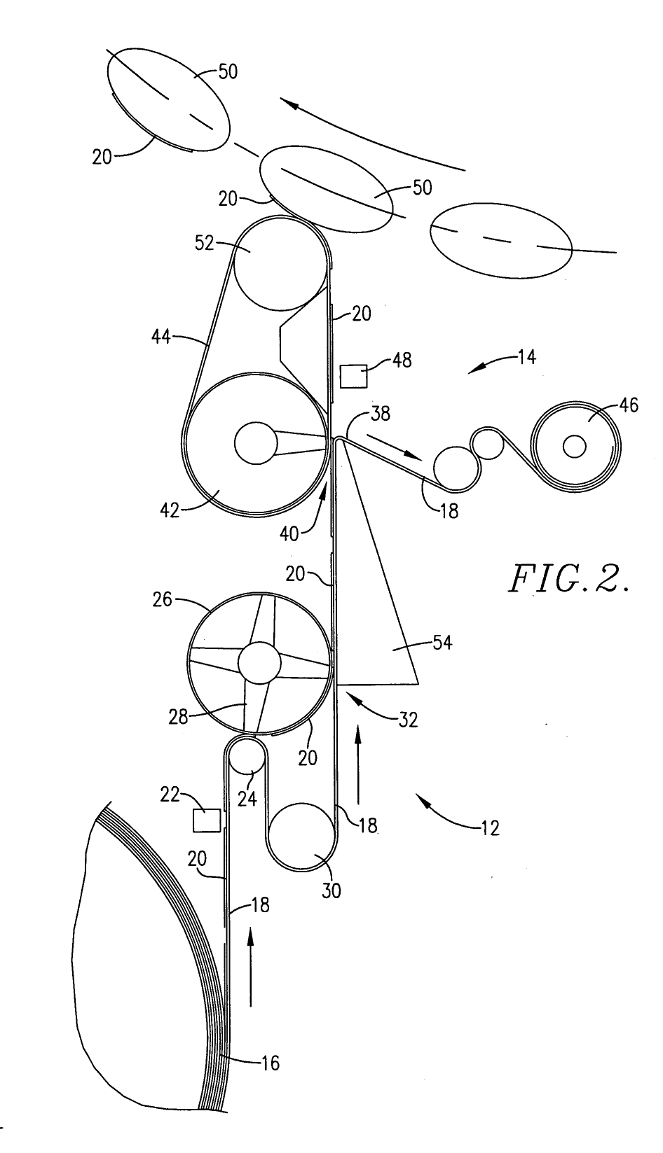

The system depicted in FIG. 2 operates in a substantially similar manner to the system shown in FIG. 1 with the exception that nip roller 34, belt 36, and peel roller 38 have been replaced with peel plate 54. All other features remain essentially unchanged from FIG. 1 and have been labeled with the same reference numerals. In operation, after labels 20 have been re-laminated to web 18 at nip 32, web 18 is directed toward nip 40 where vacuum drum 42 applies suction to label 20 proximate the leading edge thereof and web 18 is directed around peel plate 54 thereby stripping web 18 from labels 20.

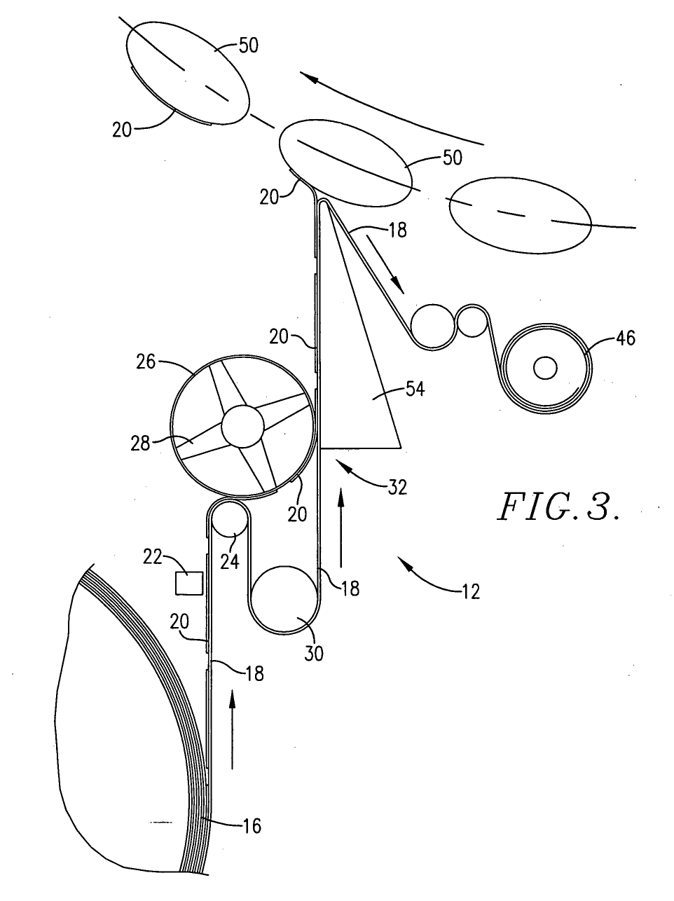

FIG. 3 depicts an alternate embodiment according to the present invention. Label pre-release station 12 is identical to that shown in FIG. 2. All corresponding elements are marked with the same reference numerals. However, FIG. 3 does not depict a corresponding label application station. Rather, labels 20 are directly applied to products 50 as web 18 is directed around peel plate 54. The release values of the particular labels 20 used with this system have been sufficiently decreased by the pre-release operation so that any further vacuum assist in stripping web 18 from labels 20 is unnecessary.

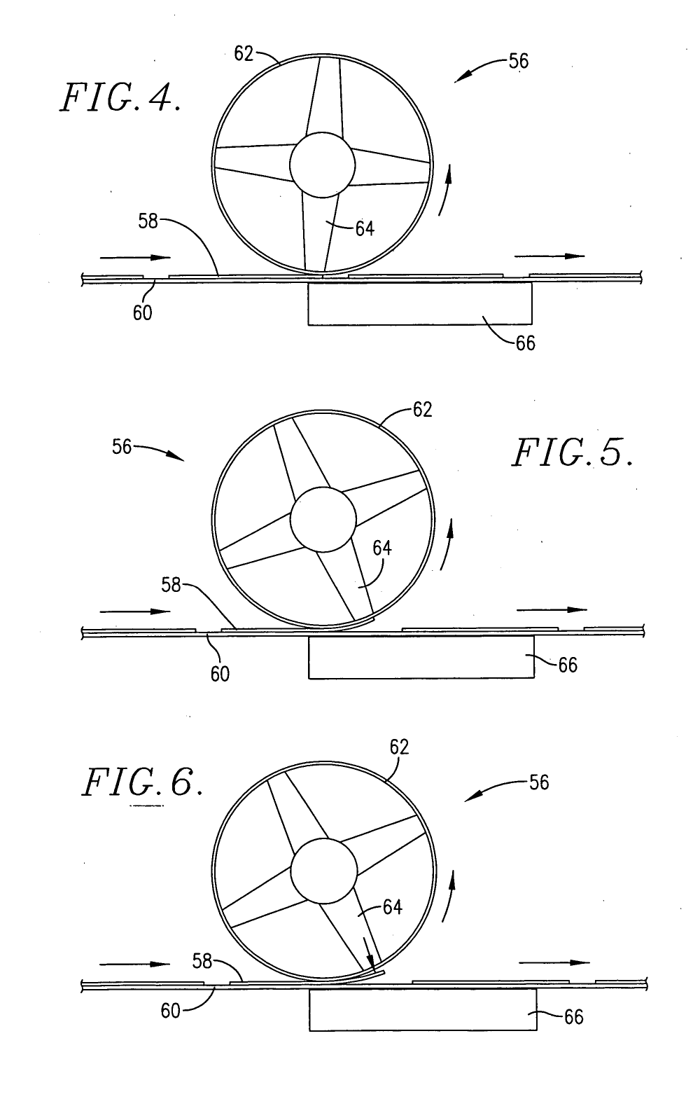

FIGS. 4-6 depict a further pre-release configuration 56 wherein labels 58 are only partially delaminated from carrier web 60. Beginning with FIG. 4, label 58 approaches vacuum drum 62 at which time a vacuum is drawn through aperture 64 thereby adhering the leading portion of label 58 to vacuum drum 62. At the same time, a vacuum former 66 is employed to maintain suction on web 60. As web 60 advances (FIG. 5), vacuum drum 62 rotates in a counterclockwise manner thereby separating the leading portion of label 58 from web 60. Web 60 remains adhered to vacuum former 66 thereby ensuring this separation. Preferably, at least about 5% of label 58 is separated from web 60, more preferably up to about 50% of label 58 is separated, even more preferably between about 5-50% of label 58 is separated, and most preferably between about 10-20% of label 58 is separated. An important distinction of this embodiment over those described above is that less than all of the label is delaminated from the carrier web.

As shown in FIG. 6, after at least a portion of label 58 is separated from web 60, the vacuum in aperture 64 is shut off and a burst of positive pressure air is passed there through to blow the separated portion of label 58 back down onto web 60. Web 60 then continues on toward a label application station such as any of those described previously herein.

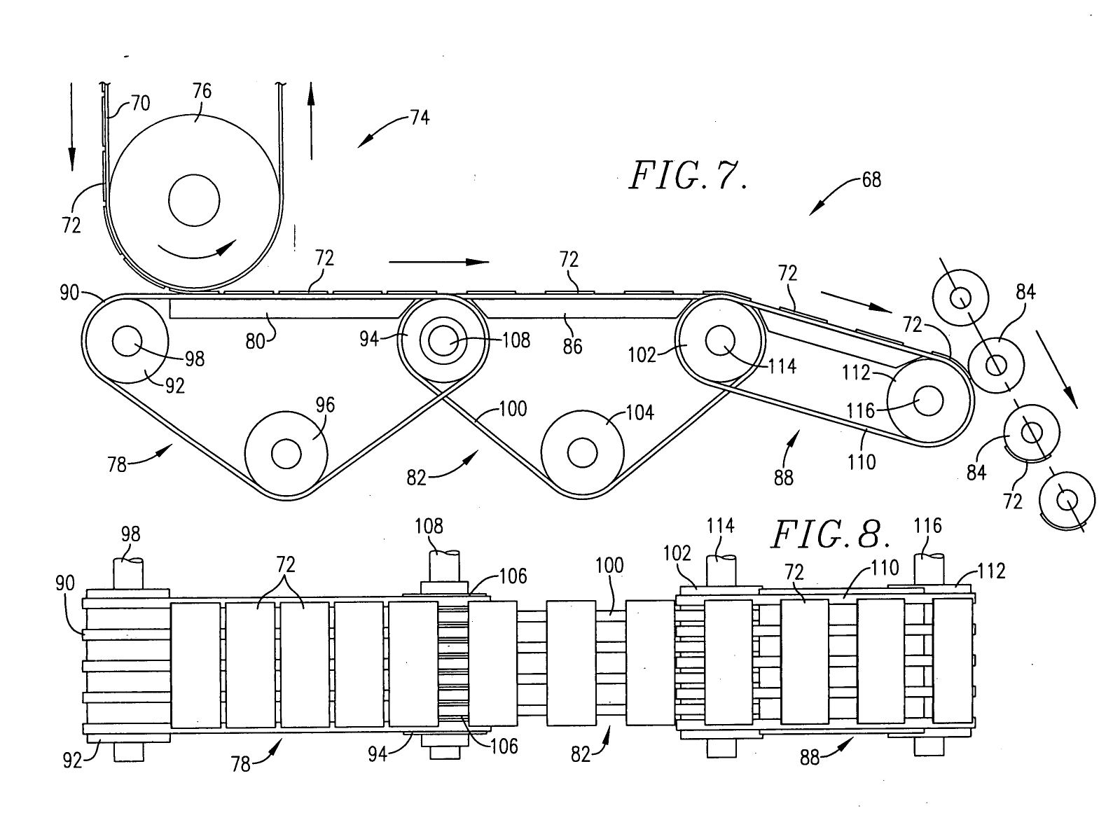

FIG. 7 depicts yet another embodiment of the present invention that employs vacuum assist in order to delaminate labels from a carrier web. In addition, FIG. 7 illustrates a preferred label pitching assembly 68 whereby the pitch between labels is adjusted to match the pitch of the products to which the labels are to be applied. A carrier web 70 having a plurality of labels 72 positioned thereon is supplied to a label release station 74. Web 70 is drawn between roller 76 and a vacuum belt assembly 78. As labels 72 are contacted with vacuum belt assembly 78, suction supplied from vacuum former 80 adheres labels 72 to assembly 78. The force with which labels 72 are adhered to assembly 78 is greater than the release value of the labels from web 70. Therefore, as web 70 is drawn around roller 76, labels 72 are stripped from web 70.

Next, labels 72 are transferred to a pitching belt assembly 82 wherein the pitch or spacing between successive labels 72 is adjusted to match the pitch of products 84. In order to accomplish this pitching, pitching belt assembly 82 operates at a different speed from vacuum belt assembly 78. As labels 72 are likely to be closely positioned on web 70, the pitch between labels will likely need to be adjusted upward. Therefore, it is preferably that pitching belt assembly 82 operates at a faster speed than vacuum belt assembly 78. As with vacuum belt assembly 78, labels 72 remain adhered to pitching belt assembly 82 by drawing a vacuum through former 86. Finally, labels 72 are transferred to a label application belt assembly 88 for application to individual products 84.

FIG. 8 is a top view of the apparatus shown in FIG. 7. Vacuum belt assembly 78 comprises five individual belts 90 entrained around rollers 92, 94, and 96. Power to roller 92 may be supplied by a motor connected to shaft 98. Labels 72 are subsequently transferred to pitching belt assembly 82 which comprises four belts 100 entrained around rollers 94, 102, and 104. Vacuum belt assembly 78 and pitching belt assembly 82 share roller 94 in common. However, the belts on each assembly rotate at a different speed. Therefore, roller 94 preferably comprises a plurality of independently rotatable pulleys 106 mounted on shaft 108. Next, labels 72 are transferred to label application belt assembly 88 which comprises five belts 110 entrained around rollers 102 and 112. In order to maintain the pitch between labels 72 established by pitching belt assembly 82, application belt assembly 88 operates at the same speed as pitching belt assembly 82. Therefore, even though belts 100 and 110 are arranged in an alternating fashion on roller 102, roller 102 need not comprise independently rotatable pulleys as does roller 94. In fact, pitching belt assembly 82 and application belt assembly 88 may be powered by the same motor located on either of shafts 114 or 116.

1. A method of applying labels to products comprising the steps of:
(a) guiding a web comprising a plurality of pre-printed labels along a path;
(b) applying a first vacuum to at least one of said labels using a vacuum drum rotating in a first direction, said vacuum being applied proximate the leading edge of said at least one label as said web travels along said path thereby adhering said leading edge to said vacuum drum;
(c) continuing to rotate said vacuum drum in said first direction thereby separating at least the leading edge of said label from said web as said web continues along said path;
(d) using said vacuum drum to reapply said leading edge of said at least one label onto said web; and
(e) transporting said at least one label to a label application station where said at least one label is applied to a product.

2. The method of claim 1, step (c) resulting in the separation of at least about 5% of said at least one label from said web.

3. The method of claim 1, step (c) resulting in the separation of up to about 50% of said at least one label from said web.

4. The method of claim 1, step (d) comprising releasing said first vacuum and applying a burst of positive pressure air to said at least one label to force said leading edge back toward said web.

5. The method of claim 1, step (e) including the steps of:
(i) applying a second vacuum to said at least one label proximate the leading edge thereof;
(ii) stripping said web from said at least one label by directing said web past a peel plate or a peel roller, said web being taken up on a waste roll; and
(iii) applying said at least one label to a product.

6. The method of claim 1, step (e) comprising stripping said web from said at least one label by directing said web past a peel plate, said web subsequently being taken up on a waste roll.

7. The method of claim 1, step (c) including:
stripping said least one label from said web as said web travels along said path.

8. The method of claim 7, step (c) further comprising directing said web about a nip roller thereby separating said at least one label from said web.

9. The method of claim 7, step (d) comprising directing said web and said at least one label to a nip whereby said at least one label is rejoined with said web.

10. (canceled)

11. (canceled)

12. A method of applying labels to products comprising the steps of:
(a) guiding a web comprising a plurality of pre-printed labels along a path;
(b) applying a vacuum to at least one of said labels proximate at least the leading edge thereof as said web travels along said path, said vacuum applied by a first vacuum belt;
(c) stripping said web from said at least one label, said at least one label being adhered to said first vacuum belt;
(d) transferring said at least one label from said first vacuum belt to a pitching belt, said pitching belt altering the pitch between said at least one label and at least one other label; and
(e) transferring said at least one label from said pitching belt to an application belt which transports said at least one label to a label application station.

13. The method of claim 12, said pitching belt being rotated at a higher velocity than said first vacuum belt.

14. The method of claim 12, said pitching belt comprising a second vacuum belt and said application belt comprising a third vacuum belt.

15-19. (canceled)

20. A method of applying labels to products comprising the steps of:
(a) guiding a web comprising a plurality of pre-printed labels along a path;
(b) applying a first vacuum to at least one of said labels proximate the leading edge thereof and separating said leading edge from said web as said web travels along said path;
(c) immediately reapplying said leading edge of said at least one label on said web as said web continues along said path; and
(d) transporting said at least one label to a label application station where said at least one label is stripped from said web and applied to a product.

21. The method of claim 20, step (b) comprising separating less than all of said label from said web.

22. The method of claim 20, said labels having a thickness of between about 0.1-3 mils.

23. The method of claim 20, said labels comprising release values of at least 15 grams as determined by Finat testing procedures.

24. The method of claim 20, step (c) comprising releasing said first vacuum and applying a burst of positive pressure air to said at least one label to force said leading edge back toward said web.

25. The method of claim 20, step (d) including the steps of:
(i) applying a second vacuum to said at least one label proximate the leading edge thereof;
(ii) stripping said web from said at least one label by directing said web past a peel plate or a peel roller, said web being taken up on a waste roll; and
(iii) applying said at least one label to a product.

26. The method of claim 20, step (e) comprising stripping said web from said at least one label by directing said web past a peel plate, said web subsequently being taken up on a waste roll.
